(19) United States
(12) Patent Application Publication
(10) Pub. No.: US 2014/0157122 A1
(43) Pub. Date: Jun. 5, 2014

(54) ELECTRONIC DEVICE

(71) Applicant: NIKON CORPORATION, Tokyo (JP)

(72) Inventors: Taro Matsuo, Yokosuka (JP); Kiyoshi Okabe, Tokyo (JP)

(73) Assignee: NIKON CORPORATION, Tokyo (JP)

(21) Appl. No.: 14/173,081

(22) Filed: Feb. 5, 2014

Related U.S. Application Data
(63) Continuation of application No. PCT/JP2012/070194, filed on Aug. 8, 2012.

(30) Foreign Application Priority Data
Aug. 9, 2011 (JP) 2011-174144

(51) Int. Cl. G06F 3/01; G06F 3/0484

(52) U.S. Cl. CPC G06F 3/016; G06F 3/0484
USPC 715/702

(57) ABSTRACT

An electronic device is an electronic device including: a detection unit configured to detect movement of a housing; a vibration unit configured to vibrate the housing; a determination unit configured to calculate movement of a virtual container and movement of a virtual object, and detect a relative distance between an inner wall of the virtual container and the virtual object, the virtual container being moved according to the movement of the housing, the virtual object being moved in the virtual container according to the movement of the virtual container; and an output information generation unit configured to output vibration information used to vibrate the vibration unit to the vibration unit when the determination unit determines that the relative distance between the inner wall of the virtual container and the virtual object satisfies a predetermined distance relationship.

### CROSS-REFERENCE TO RELATED APPLICATION

This is a Continuation Application of International Application No. PCT/JP2012/070194, filed Aug. 8, 2012, which claims priority to Japanese Patent Application No. 2011-174144, filed on Aug. 9, 2011. The contents of the aforementioned applications are incorporated herein by reference.

### BACKGROUND

1. Field of the Invention

The present invention relates to an electronic device.

2. Description of Related Art

Currently, there is a mobile device having a function of outputting a sound, a function of vibrating the housing, and a function of detecting the movement of the housing. In addition, techniques used to generate a collision sound when a virtual object collides in a virtual space are disclosed (for example, refer to Japanese Unexamined Patent Application, First Publication No. 2007-164291).

### SUMMARY

However, there is a problem in that, when a user moves the housing of a mobile device by shaking or the like, even if a collision sound or vibration is generated by moving a virtual object in the virtual space corresponding to the contour of the housing, it is not practically possible to make the user experience a sense of reality as if something, such as a real ball, is contained inside the housing.

According to an aspect of the present invention, there is provided a technique used to make a user experience a sense of reality as if something, such as a real ball, is contained inside the housing of a mobile device when the user moves the housing by, for example, shaking it.

An electronic device according to an aspect of the present invention is an electronic device including: a detection unit configured to detect movement of a housing; a vibration unit configured to vibrate the housing; a determination unit configured to calculate movement of a virtual container and movement of a virtual object, and detect a relative distance between an inner wall of the virtual container and the virtual object, the virtual container being moved according to the movement of the housing, the virtual object being moved in the virtual container according to the movement of the virtual container; and an output information generation unit configured to output vibration information used to vibrate the vibration unit to the vibration unit when the determination unit determines that the relative distance between the inner wall of the virtual container and the virtual object satisfies a predetermined distance relationship.

An electronic device according to another aspect of the present invention is an electronic device including: a detection unit configured to detect movement of a housing; a sound output unit configured to output a sound; a determination unit configured to calculate movement of a virtual container and movement of a virtual object, and detects a relative distance between the virtual objects, the virtual container being moved according to the movement of the housing, the virtual object being moved in the virtual container according to the movement of the virtual container; and an output information generation unit configured to output sound information used to output the sound to the sound output unit when the determination unit determines that the relative distance between the virtual objects satisfies a predetermined distance relationship.

According to aspects of the present invention, when a user moves the housing of the electronic device according to the present invention by shaking or the like, it is possible for the user to experience a sense of reality as if something, such as a real ball, is contained inside the housing.

### BRIEF DESCRIPTION OF THE DRAWINGS

FIG. 1 is an example of a functional block diagram of an electronic device according to an embodiment of the present invention.

FIG. 2A is an example of information stored in a physical information storage unit.

FIG. 2B is an example of information stored in a physical information storage unit.

FIG. 2C is an example of information stored in a physical information storage unit.

FIG. 3A is an example of information stored in an output information storage section.

FIG. 3B is an example of information stored in an output information storage section.

FIG. 3C is an example of information stored in an output information storage section.

FIG. 3D is an example of information stored in an output information storage section.

FIG. 4A is a flowchart showing an example of the operation of an electronic device.

FIG. 4B is a flowchart showing an example of the operation of an electronic device.

FIG. 5 is an explanatory diagram which shows the operation of an electronic device.

### DESCRIPTION OF EMBODIMENTS

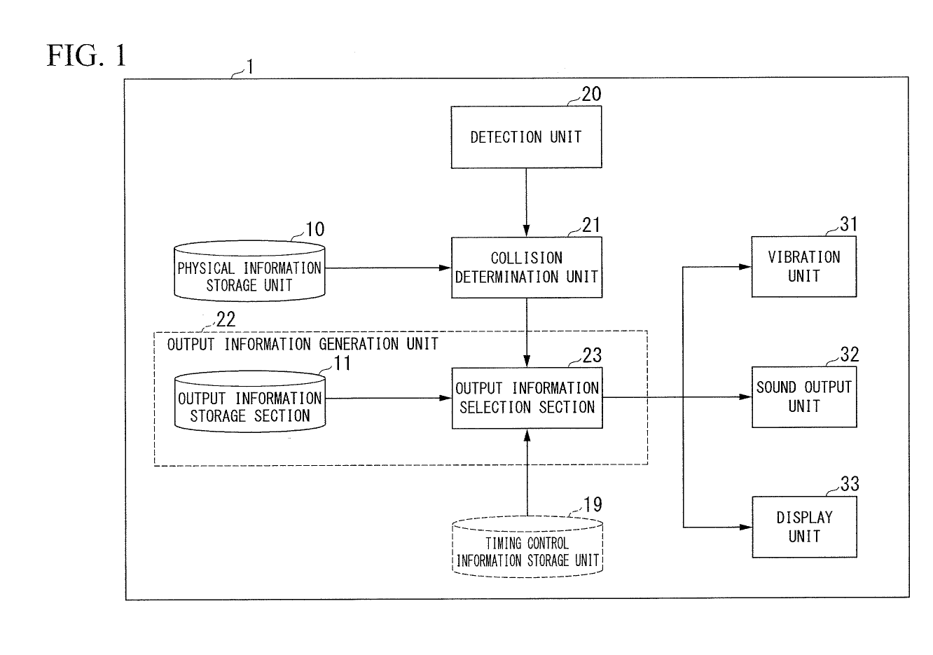

Hereinafter, embodiments of the present invention will be described with reference to the diagrams. FIG. 1 is an example of the functional block diagram of an electronic device 1 according to an embodiment of the present invention.

As shown in FIG. 1, the electronic device 1 includes a physical information storage unit 10, a detection unit 20, a collision determination unit 21, an output information generation unit 22, a vibration unit 31, a sound output unit 32, and a display unit 33. The output information generation unit 22 includes an output information storage section 11 and an output information selection section 23. In addition, as shown by the dotted line, the electronic device 1 may be configured to further include a timing control information storage unit 19.

The vibration unit 31 is a vibration motor, for example, and vibrates a housing of the electronic device 1 (hereinafter, simply referred to as a housing). Specifically, the vibration unit 31 vibrates the housing according to vibration information output from the output information generation unit 22.

The sound output unit 32 is a speaker, for example, and outputs a sound to the outside of the housing. Specifically, the sound output unit 32 outputs a sound to the outside of the housing according to sound information output from the output information generation unit 22.

The display unit 33 is an LCD monitor, for example, and displays various kinds of information. Specifically, the display unit 33 displays image information output from the output information generation unit 22, for example.

The detection unit 20 detects the movement of the housing. For example, the detection unit 20 is an acceleration sensor, and detects the acceleration applied to the housing and detects the movement of the housing on the basis of the detected acceleration.

The collision determination unit 21 is a physical engine that calculates the movement of a virtual container that moves according to the movement of the housing and the movement of a virtual object that moves around in the virtual container according to the movement of the virtual container on the basis of the movement of the housing detected by the detection unit 20. Specifically, the collision determination unit 21 calculates the movement of the virtual container and the virtual object on the basis of the movement information of the housing detected by the detection unit 20 and the information stored in the physical information storage unit 10.

In addition, the collision determination unit 21 determines the presence or absence of a collision of the virtual object to an inner wall of the virtual container and the presence or absence of a collision between the virtual objects by calculating the movement of the virtual container and the virtual object. In addition, details of the information stored in the physical information storage unit 10 and details of the calculation of the movement of the virtual container and the virtual object and the determination regarding the presence or absence of a collision of the virtual object to the inner wall of the virtual container and the presence or absence of a collision between the virtual objects by the collision determination unit 21 will be described later.

The output information generation unit 22 generates output information (vibration information output to the vibration unit 31, sound information output to the sound output unit 32, and image information output to the display unit 33). For example, the output information generation unit 22 generates vibration information output to the vibration unit 31 when the collision determination unit 21 determines that there has been a collision of the virtual object to the inner wall of the virtual container. In addition, the output information generation unit 22 generates sound information output to the sound output unit 32 when the collision determination unit 21 determines that there has been a collision between the virtual objects. In addition, while the collision determination unit 21 determines the presence or absence of a collision described above, the output information generation unit 22 generates video information output to the display unit 33 regardless of the presence or absence of a collision. For example, the output information generation unit 22 generates video information showing the movement of the virtual object that moves around in the virtual container.

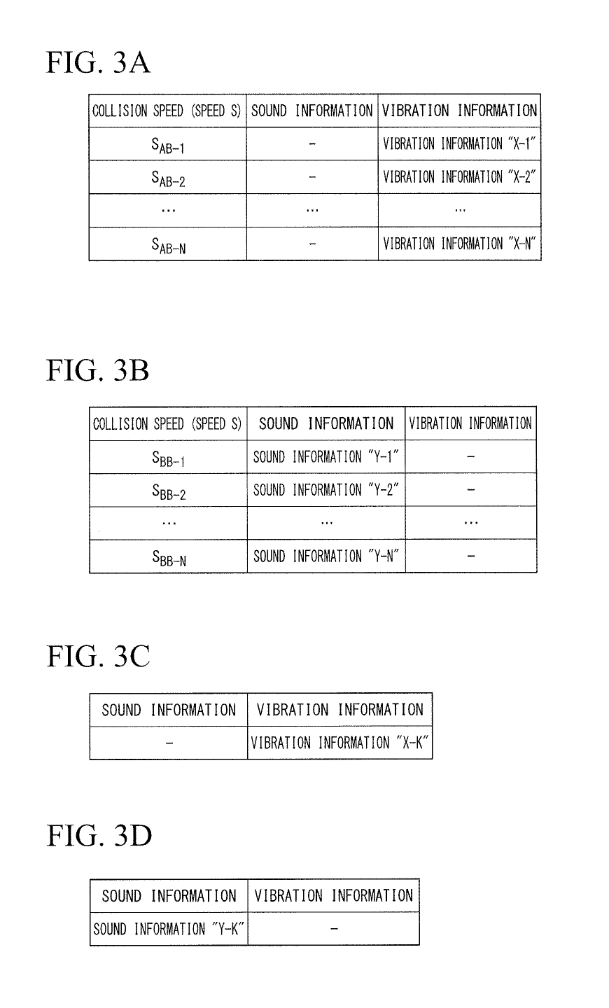

Specifically, when outputting the vibration and sound corresponding to the collision speed (speed of collision of the virtual object to the inner wall of the virtual container, speed of collision between the virtual objects), the output information selection section 23 of the output information generation unit 22 generates vibration information and sound information on the basis of the movement information of the virtual container and the virtual object (speed of collision of the virtual object to the inner wall of the virtual container, speed of collision between the virtual objects) calculated by the collision determination unit 21, the determination information regarding the presence or absence of a collision (information regarding the determination of the collision of the virtual object to the inner wall of the virtual container, information regarding the determination of the collision between the virtual objects) determined by the collision determination unit 21, the information (setting information shown in FIG. 3C to be described later) stored in the physical information storage unit 10, and the information stored in the output information storage section 11. In addition, when vibration and sound are not output corresponding to the collision speed, the output information selection section 23 generates vibration information and sound information on the basis of the information regarding the determination of the presence or absence of a collision determined by the collision determination unit 21, the information stored in the physical information storage unit 10, and the information stored in the output information storage section 11. In addition, the output information generation unit 22 may acquire the information stored in the physical information storage unit 10 through the collision determination unit 21.

In addition, the output information selection section 23 generates video information on the basis of the movement information of the virtual object calculated by the collision determination unit 21 and the information stored in the physical information storage unit 10.

In addition, details of the information stored in the output information storage section 11 and details related to the selection of the output information by the output information selection section 23 will be described later.

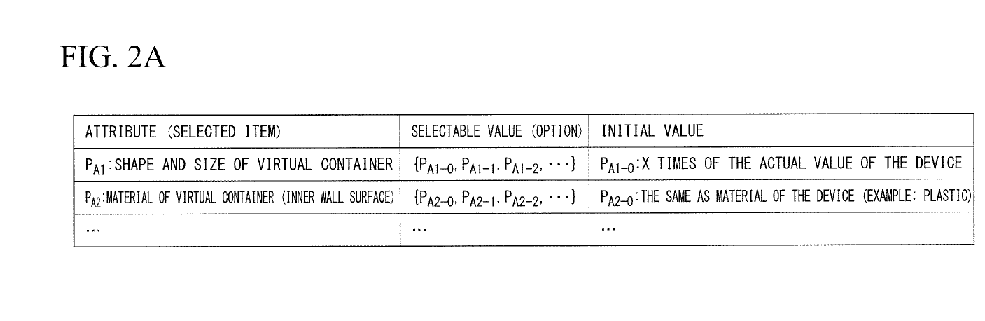

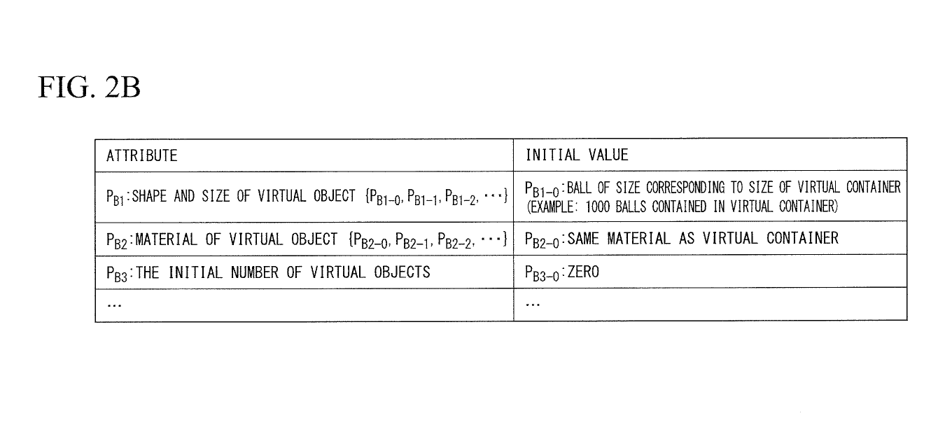

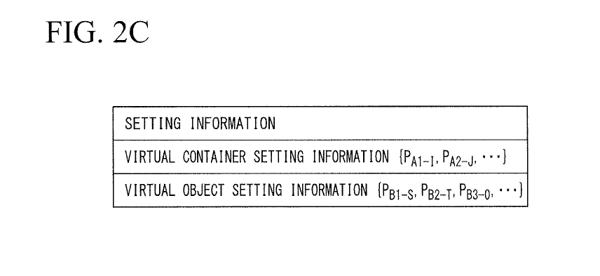

Subsequently, the information stored in the physical information storage unit 10 will be described. FIGS. 2A to 2C are examples of the information stored in the physical information storage unit 10. As shown in FIG. 2A, the physical information storage unit 10 stores the selection information of the virtual container. In the selection information of the virtual container shown in FIG. 2A, a selectable value (option) and an initial value are stored so as to correspond to various attributes (selected items) related to the virtual container. For example, a selectable value {P_{A1-0}, P_{A1-1}, and P_{A1-2}, . . . } and an initial value {P_{A1-0}} prepared in advance as the shape and size of the virtual container are stored so as to correspond to an attribute (P_{A1}) showing the shape and size of the virtual container. In addition, for example, a selectable value {P_{A2-0}, P_{A2-1}, and P_{A2-2}, . . . } and an initial value {P_{A2-0}} prepared in advance as a material of the virtual container are stored so as to correspond to an attribute (P_{A2}) showing the material of the virtual container.

As described above, a user can be made to select the setting value of each attribute of the virtual container freely by storing the selection information of the virtual container in advance. For example, selectable values of each attribute of the virtual container may be displayed on the display unit 33, so that the user can select one of the selectable values for each attribute as a setting value through an operation receiving unit (not shown). In addition, for an attribute that is not selected, the initial value may be set as a setting value.

In addition, as shown in FIG. 2B, the physical information storage unit 10 stores the selection information of the virtual object. In the selection information of the virtual object shown in FIG. 2B, a selectable value and an initial value are stored so as to correspond to various attributes related to the virtual object. For example, a selectable value {P_{B1-0}, P_{B1-1}, and P_{B1-2}, . . . } and an initial value {P_{B1-0}} prepared in advance as the shape and size of the virtual object are stored so as to correspond to an attribute (P_{B1}) showing the shape and size of the virtual object. In addition, for example, a selectable value {P_{B2-0}, P_{B2-1}, and P_{B2-2}, . . . } and an initial value {P_{B2-0}} prepared in advance as a material of the virtual object are stored so as to correspond to an attribute (P_{B2}) showing the material of the virtual object.

In addition, the number of virtual objects is determined by the operation of the user. For example, one virtual object may be added whenever the user touches an add button (not shown) disposed at the display unit 33. Specifically, since the initial number of virtual objects is zero in the case of the example shown in FIG. 2B, the number of virtual objects is N when the user touches the add button N times. In addition, a delete button (not shown) may be disposed at the display unit 33, so that the number of virtual objects can be reduced. In addition, in the example shown in FIG. 2B, the initial number is set to zero and no option is prepared. However, an option may be prepared for the initial number in the same manner as for the shape and size, the material, and the like.

As described above, a user can be made to select the setting value of each attribute of the virtual object freely by storing the selection information of the virtual object in advance. For example, selectable values of each attribute of the virtual object may be displayed on the display unit 33, so that the user can select one of the selectable values for each attribute as a setting value through an operation receiving unit (not shown). In addition, for an attribute that is not selected, the initial value may be set as a setting value.

In addition, as shown in FIG. 2C, the physical information storage unit 10 stores setting information configured to include virtual container setting information and virtual object setting information.

The virtual container setting information is a selection result from the selection information of the virtual container shown in FIG. 2A. That is, virtual container setting information {P_{A1-I}, P_{A2-J}, . . . } shown in FIG. 2C stores that a value “P_{A1-I}” has been selected as a setting value from the selectable values of the attribute (P_{A1}) and a value “P_{A2-J}” has been selected as a setting value from the selectable values of the attribute (P_{A2}).

The virtual object setting information is a selection result from the selection information of the virtual object shown in FIG. 2B. That is, virtual object setting information {P_{B1-S}, P_{B2-T}, P_{B3-0}, . . . } shown in FIG. 2C stores that a value “P_{B1-S}” has been selected as a setting value from the selectable values of the attribute (P_{B1}), a value “P_{B2-T}” has been selected as a setting value from the selectable values of the attribute (P_{B2}), and a value “P_{B3-0}” has been selected as a setting value from the selectable values of the attribute (P_{B3}).

Then, the calculation of the movement of the virtual container and the virtual object and the determination regarding the presence or absence of a collision of the virtual object to the inner wall of the virtual container and the presence or absence of a collision between the virtual objects by the collision determination unit 21 will be described. The collision determination unit 21 reads and stores the setting information (virtual container setting information and virtual object setting information), which is stored in the physical information storage unit 10, in advance. In addition, the collision determination unit 21 stores the number of virtual objects determined by the operation of the user.

The collision determination unit 21 acquires the movement information of the housing detected by the detection unit 20. The collision determination unit 21 that has acquired the movement information of the housing detected by the detection unit 20 calculates the movement of the virtual container on the basis of the movement information of the housing (that is, generates the movement information of the virtual container). For example, the collision determination unit 21 may determine the movement of the housing to be the movement of the virtual container.

The collision determination unit 21 that has calculated the movement of the virtual container determines the collision (collision of the virtual object to the inner wall of the virtual container and collision between the virtual objects) and calculates the movement of each virtual object (that is, generates the movement information of the virtual object) while calculating the moving direction and moving speed of the virtual object after collision on the basis of the movement information of the virtual container, the stored setting information (shape and size of the virtual container (setting value of the attribute (P_{A1})), the shape and size of the virtual object (setting value of the attribute (P_{B1})), the material of the virtual container (setting value of the attribute (P_{A2})), the material of the virtual object (setting value of the attribute (P_{B2})), and the like), and the stored information regarding the number of virtual objects. In addition, for example, the materials of the virtual container and the virtual object are used in the above-described calculation as the repulsive force and the friction coefficient.

In addition, it has been described that the collision determination unit 21 determines the presence or absence of a collision of the virtual object to the inner wall of the virtual container and the presence or absence of a collision between the virtual objects by calculating the movement of the virtual container and the virtual object. However, as described above, the collision determination unit 21 determines the presence or absence of a collision of the virtual object to the inner wall of the virtual container and the presence or absence of a collision between the virtual objects in the process of calculating the movement of the virtual container and the virtual object.

Subsequently, the information stored in the output information storage section 11 will be described. FIGS. 3A to 3D are examples of the information stored in the output information storage section 11. The output information storage section 11 stores output information at the time of collision of the virtual object to the inner wall of the virtual container and output information at the time of collision between the virtual objects.

In the electronic device 1, in order to realize an output (vibration, sound) corresponding to setting information (for example, materials of the virtual container and the virtual object), the output information storage section 11 stores output information at the time of collision of the virtual object to the inner wall of the virtual container and output information at the time of collision between the virtual objects for each combination of the setting information. In addition, in the electronic device 1, vibration and sound are output according to the collision speed (speed of collision of the virtual object to the inner wall of the virtual container, speed of collision between the virtual objects). Therefore, the output information storage section 11 stores output information at the time of collision of the virtual object to the inner wall of the virtual container and output information at the time of collision between the virtual objects for each collision speed.

FIG. 3A is an example of the output information at the time of collision of the virtual object to the inner wall of the virtual container that is stored in the output information storage section 11. The output information at the time of collision of the virtual object to the inner wall of the virtual container shown in FIG. 3A is output information at the time of collision of the virtual object to the inner wall of the virtual container in certain setting information (specifically, setting information shown in FIG. 2C). The output information storage section 11 stores vibration information “X−1” so as to correspond to the collision speed “S_{AB-1}” of the virtual object to the inner wall of the virtual container, stores vibration information “X−2” so as to correspond to the collision speed “S_{AB-2}” of the virtual object to the inner wall of the virtual container, . . . , and stores vibration information “X−N” so as to correspond to the collision speed “S_{AB-N}” of the virtual object to the inner wall of the virtual container.

In addition, when the material of the virtual container is plastic or metal and the material of the virtual object is an elastic body of rubber, it is possible to set vibration information to vibrate the housing by generating a sine wave of about 10 Hz, for example.

That is, the output information at the time of collision of the virtual object to the inner wall of the virtual container shown in FIG. 3A indicates that, in the case of the setting shown in FIG. 2C (when the setting value of the attribute (P_{A1}) is the value “P_{A1-I}”, the setting value of the attribute (P_{A2}) is the value “P_{A2-J}”, . . . , the setting value of the attribute (P_{B1}) is the value “P_{B1-S}”, the setting value of the attribute (P_{B2}) is the value “P_{B2-T}”, the setting value of the attribute (P_{B3}) is the value “P_{B3-0}”, . . . ), the vibration information “X−1” is selected when the speed of collision of the virtual object to the inner wall of the virtual container is the collision speed “S_{AB-1}”, the vibration information “X−2” is selected when the speed of collision of the virtual object to the inner wall of the virtual container is the collision speed “S_{AB-2}”, . . . , and the vibration information “X−N” is selected when the speed of collision of the virtual object to the inner wall of the virtual container is the collision speed “S_{AB-N}”.

FIG. 3B is an example of the output information at the time of collision between the virtual objects that is stored in the output information storage section 11. The output information at the time of collision between the virtual objects shown in FIG. 3B is output information at the time of collision between the virtual objects in certain setting information (specifically, setting information shown in FIG. 2C), and stores sound information “Y−1” so as to correspond to the speed of collision “S_{BB-1}” between the virtual objects, stores sound information “Y−2” so as to correspond to the speed of collision “S_{BB-2}” between the virtual objects, . . . , and stores sound information “Y−N” so as to correspond to the speed of collision “S_{BB-N}” between the virtual objects.

That is, the output information at the time of collision between the virtual objects shown in FIG. 3B indicates that, in the case of the setting shown in FIG. 2C, the sound information “Y−1” is selected when the speed of collision between the virtual objects is the speed “S_{BB-1}”, the sound information “Y−2” is selected when the speed of collision between the virtual objects is the speed “S_{BB-2}”, . . . , and the sound information “Y−N” is selected when the speed of collision between the virtual objects is the speed “S_{BB-N}”.

In addition, in the electronic device 1, when vibration and sound are not output according to the collision speed, the output information storage section 11 may store output information at the time of collision of the virtual object to the inner wall of the virtual container and output information at the time of collision between the virtual objects for each combination of setting information, as shown in FIGS. 3C and 3D.

Subsequently, the selection of output information by the output information selection section 23 will be described. The output information selection section 23 acquires the information (setting information shown in FIG. 3C) stored in the physical information storage unit 10 from the collision determination unit 21 and stores it in advance.

(When Vibration and Sound are Output According to Collision Speed)

The output information selection section 23 acquires the movement information of the virtual container and the virtual object (speed of collision of the virtual object to the inner wall of the virtual container, speed of collision between the virtual objects) and determination information regarding the presence or absence of a collision (collision determination information regarding the collision of the virtual object to the inner wall of the virtual container, collision determination information regarding the collision between the virtual objects) from the collision determination unit 21.

When the timing at which the virtual object has collided with the inner wall of the virtual container is acquired from the collision determination information regarding the collision of the virtual object to the inner wall of the virtual container, the output information selection section 23 acquires the collision speed of the collision from the movement information of the virtual container and the virtual object and selects, from the output information storage section 11, vibration information corresponding to the collision speed among the setting information stored in advance (shape and size of the virtual container (setting value of the attribute (P_{A1})), the shape and size of the virtual object (setting value of the attribute (P_{B1})), material of the virtual container (setting value of the attribute (P_{A2})), material of the virtual object (setting value of the attribute (P_{B2})), and the like).

In addition, when the timing at which the virtual objects have collided with each other is acquired from the collision determination information regarding the collision between the virtual objects, the output information selection section 23 acquires the collision speed of the collision from the movement information of the virtual container and the virtual object and selects, from the output information storage section 11, sound information corresponding to the collision speed among the setting information stored in advance.

(When Vibration and Sound are not Output According to Collision Speed)

In addition, the output information selection section 23 acquires determination information regarding the presence or absence of a collision (collision determination information regarding the collision of the virtual object to the inner wall of the virtual container, collision determination information regarding the collision between the virtual objects) from the collision determination unit 21.

When the timing at which the virtual object has collided with the inner wall of the virtual container is acquired from the collision determination information regarding the collision of the virtual object to the inner wall of the virtual container, the output information selection section 23 selects, from the output information storage section 11, vibration information corresponding to the setting information stored in advance (shape and size of the virtual container (setting value of the attribute (P_{A1})), shape and size of the virtual object (setting value of the attribute (P_{B1})), material of the virtual container (setting value of the attribute (P_{A2})), material of the virtual object (setting value of the attribute (P_{B2})), and the like).

In addition, when the timing at which the virtual objects have collided with each other is acquired from the collision determination information regarding the collision between the virtual objects, the output information selection section 23 selects, from the output information storage section 11, sound information corresponding to the setting information stored in advance.

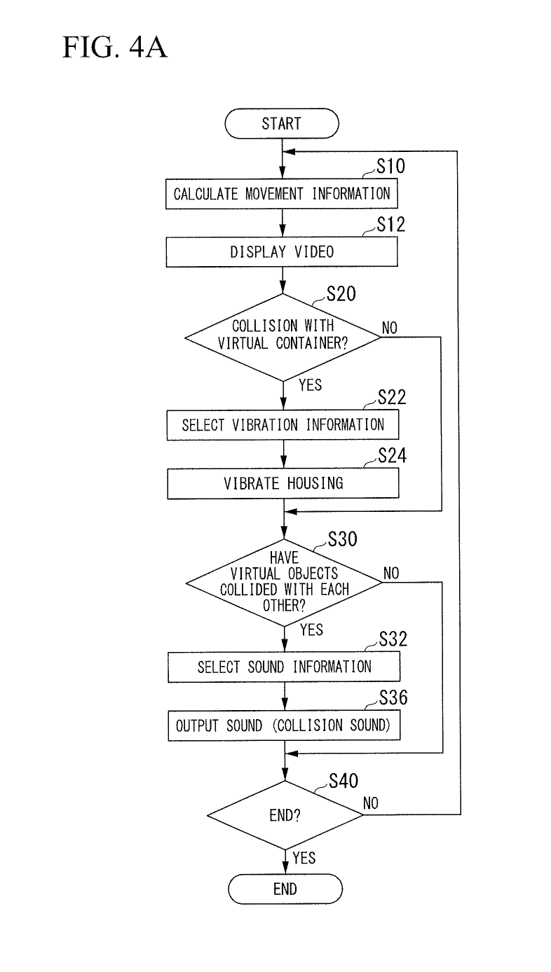

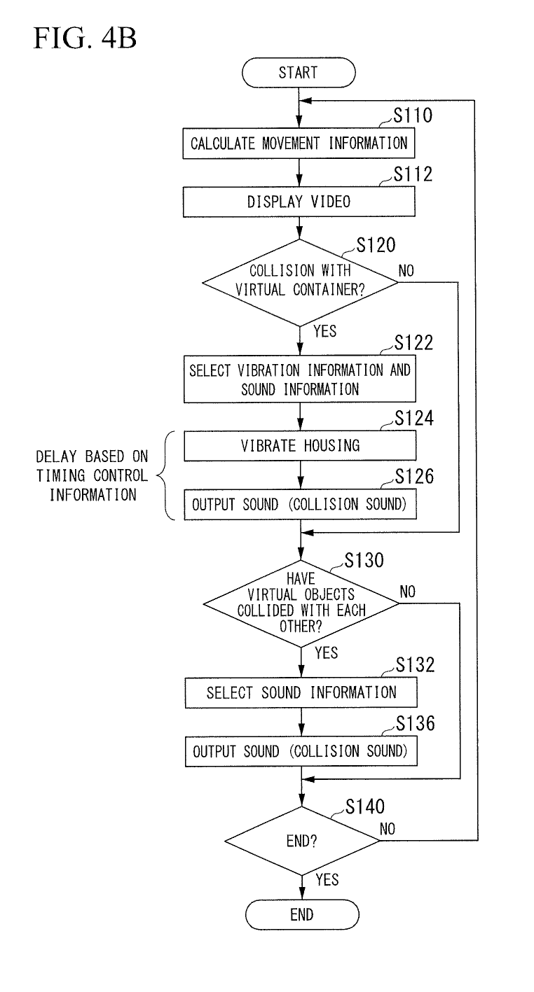

FIGS. 4A and 4B are flowcharts showing examples of the operation of the electronic device 1. Specifically, the flowcharts shown in FIGS. 4A and 4B are examples of the operation when outputting the vibration and sound according to the collision speed. In addition, it is assumed that the flowcharts shown in FIGS. 4A and 4B are started when an operation mode (hereinafter virtual collision mode) to output vibration or a collision sound is set by moving the virtual object in the virtual container. In addition, in the flowcharts shown in FIGS. 4A and 4B, the number of virtual objects is assumed to be 2 or more. In addition, the flowchart shown in FIG. 4A will be described first, and the flowchart shown in FIG. 4B will be described later.

In FIG. 4A, the collision determination unit 21 calculates the movement of the virtual container and the virtual object (step S10). The collision determination unit 21 outputs the movement information of the virtual container and the virtual object (including the speed of collision of the virtual object to the inner wall of the virtual container and the speed of collision between the virtual objects) to the output information selection section 23. The output information selection section 23 generates video information on the basis of the movement information of the virtual object and stored setting information. The output information selection section 23 that has generated the video information outputs the video information to the display unit 33, and the display unit 33 displays a video according to the video information (step S12).

The collision determination unit 21 determines the presence or absence of a collision of the virtual object to the inner wall of the virtual container (step S20). When the collision determination unit 21 determines that there has been no collision of the virtual object to the inner wall of the virtual container in step S20 (step S20: No), the process proceeds to step S30 skipping the following steps S22 and S24.

On the other hand, when the collision determination unit 21 determines that there has been a collision of the virtual object to the inner wall of the virtual container in step S20 (step S20: Yes), the collision determination unit 21 outputs determination information, which indicates that there has been a collision of the virtual object with the inner wall of the virtual container, and the speed of collision of the virtual object with the inner wall of the virtual container to the output information selection section 23. The output information selection section 23, which has acquired the determination information indicating that there has been a collision of the virtual object to the inner wall of the virtual container and the speed of collision of the virtual object to the inner wall of the virtual container, selects vibration information corresponding to the collision speed among the stored setting information from the output information storage section 11 (step S22). The output information selection section 23 that has selected the vibration information outputs the vibration information to the vibration unit 31, and the vibration unit 31 vibrates the housing according to the vibration information (step S24).

Subsequent to step S20 (No) or step S24, the collision determination unit 21 determines the presence or absence of a collision between the virtual objects (step S30). When the collision determination unit 21 determines that there has been no collision between the virtual objects in step S30 (step S30: No), the process proceeds to step S40 skipping the following steps S32 and S36.

On the other hand, when the collision determination unit 21 determines that there has been a collision between the virtual objects in step S30 (step S30: Yes), the collision determination unit 21 outputs determination information, which indicates that there has been a collision between the virtual objects, and the speed of collision between the virtual objects to the output information selection section 23. The output information selection section 23, which has acquired the determination information indicating that there has been a collision between the virtual objects and the speed of collision between the virtual objects, selects sound information corresponding to the collision speed among the stored setting information from the output information storage section 11 (step S32). The output information selection section 23 that has selected the sound information outputs the sound information to the sound output unit 32, and the sound output unit 32 outputs a sound (collision sound) according to the sound information (step S36).

Subsequent to step S30 (No) or step S36, it is determined whether or not the virtual collision mode has ended (step S40). When it is determined that the virtual collision mode has not ended (step S40: No), the process returns to step S10. On the other hand, when it is determined that the virtual collision mode has ended (step S40: Yes), the flowchart shown in FIG. 4A terminates.

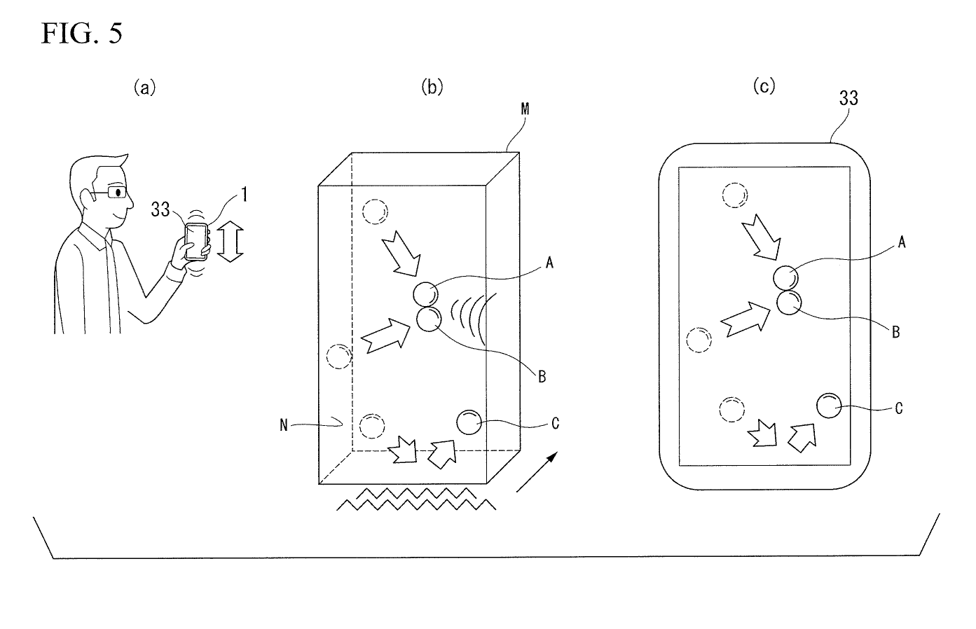

FIG. 5 is an explanatory diagram which shows the operation of the electronic device 1.

As described above, the electronic device 1 outputs a collision sound when virtual objects collide with each other, while the electronic device 1 simply vibrates the housing without outputting a collision sound when the virtual object collides with the virtual container M. Therefore, when the user moves the housing by shaking or the like (refer to part (a) of FIG. 5), it is possible for the user to experience a sense of reality as if something, such as a real ball, is contained inside the housing, as shown in part (b) of FIG. 5. That is, in the example shown in FIG. 5, a collision sound is output at a timing at which virtual objects A and B collide with each other, and the housing is made to vibrate at a timing at which a virtual object C collides with an inner wall N of the virtual container M.

In addition, as shown in part (c) of FIG. 5, since the movement of the virtual object that moves around in the virtual container M can also be checked through the display unit 33, the user can experience a sense of reality even more. In addition, in part (c) of FIG. 5, the movement of the virtual object is displayed in a two-dimensional manner without displaying the virtual container M (specifically, movement from the arrow direction shown in part (b) of FIG. 5 is displayed). However, as shown in part (b) of FIG. 5, virtual objects may be displayed in a three-dimensional manner together with the virtual container M.

In addition, in the above embodiment, an aspect in which the housing is made to vibrate without outputting a collision sound when a virtual object collides with a virtual container has been described. In this case, however, it is also possible to output a collision sound at a timing delayed from the vibration timing while vibrating the housing. Also in the aspect in which a collision sound is output at a timing delayed from the vibration timing of the housing while vibrating the housing when a virtual object collides with a virtual container, it is possible for the user to experience a sense of reality as if something, such as a real ball, is contained inside the housing, as in the aspect in which the housing is made to vibrate without outputting a collision sound when a virtual object collides with a virtual container.

Hereinafter, an aspect will be described in which a collision sound is output at a timing delayed from the vibration timing of the housing while vibrating the housing when a virtual object collides with a virtual container.

In the case of the above aspect, the electronic device 1 further includes the timing control information storage unit 19 shown by the dotted line in FIG. 1. The timing control information storage unit 19 stores the delay time between the vibration timing and the output timing of the collision sound as timing control information.

In addition, in the case of the aspect, the output information storage section 11 stores sound information and vibration information as output information at the time of collision of the virtual object to the inner wall of the virtual container for each piece of setting information (so as to correspond to the collision speed when outputting vibration and a sound according to the collision speed).

In addition, in the case of the above aspect, when the collision determination unit 21 determines that there has been a collision of the virtual object to the inner wall of the virtual container, the output information selection section 23 selects vibration information and sound information with reference to the output information storage section 11, and outputs the vibration information to the vibration unit 31 and outputs the sound information to the sound output unit 32 at a timing delayed from the output timing of the vibration information to the vibration unit 31 by the delay time based on the timing control information.

As described above, it is possible to realize the aspect in which a collision sound is output at a timing delayed from the vibration timing of the housing while vibrating the housing when a virtual object collides with a virtual container.

The flowchart shown in FIG. 4B is a flowchart showing an example of the operation when outputting vibration and a sound according to the collision speed in the aspect in which a collision sound is output at a timing delayed from the vibration timing of the housing while vibrating the housing when a virtual object collides with a virtual container. In addition, since steps S110, S112, S120, S130, S132, S136, and S140 shown in FIG. 4B are the same as steps S10, S12, S20, S30, S32, S36, and S40 shown in FIG. 4A, some or all of the explanation will be omitted here.

When the collision determination unit 21 determines that there has been a collision of the virtual object to the inner wall of the virtual container in step S120 (step S120: Yes), the collision determination unit 21 outputs determination information indicating that there has been a collision of the virtual object to the inner wall of the virtual container, the speed of collision of the virtual object to the inner wall of the virtual container, determination information indicating that there is a collision between the virtual objects, and the speed of collision between the virtual objects to the output information selection section 23. The output information selection section 23 that has acquired such information selects, from the output information storage section 11, vibration information corresponding to the speed of collision of the virtual object to the inner wall of the virtual container and sound information corresponding to the speed of collision between the virtual objects in the stored setting information (step S122).

Subsequent to step S122, the output information selection section 23 outputs the vibration information to the vibration unit 31, and the vibration unit 31 vibrates the housing according to the vibration information (step S124). In addition, the output information selection section 23 outputs the sound information to the sound output unit 32 at a timing delayed from the output timing of the vibration information to the vibration unit 31 by the delay time stored in the timing control information storage unit 19, and the sound output unit 32 outputs a sound (collision sound) according to the sound information (step S126). The following is the same as FIG. 4A.

In addition, the vibration unit 31 may be a vibration motor that vibrates each of a plurality of portions of the housing. In other words, the vibration unit 31 may be formed by a plurality of vibration motors that vibrate respective portions of the housing. When the vibration unit 31 is formed by the plurality of vibration motors described above, the output information selection section 23 may generate vibration information to vibrate a portion corresponding to the collision point when the collision determination unit 21 determines that there has been a collision of the virtual object to the inner wall of the virtual container. In this case, since the vibration unit 31 vibrates a portion corresponding to the collision point, the user can experience a sense of reality even more.

In addition, the above-described various kinds of processing related to each process of the electronic device 1 according to the embodiment of the present invention may be performed by recording a program, which is used to perform each process of the electronic device 1 according to the embodiment of the present invention, in a computer-readable recording medium, used to read the program recorded in the recording medium into a computer system, and used to execute the program. In addition, the “computer system” referred to herein may include an OS or hardware, such as peripheral devices. In addition, the “computer system” may also include a homepage providing environment (or display environment) if a WWW system is used. In addition, the “computer-readable recording medium” refers to writable nonvolatile memories such as a flexible disk, a magneto-optical disc, a ROM, and a flash memory, portable media such as a CD-ROM, and a storage unit such as a hard disk built in a computer system.

In addition, the “computer-readable recording medium” also includes a medium that stores a program for a predetermined period of time, such as a volatile memory (for example, a dynamic random access memory (DRAM)) in a computer system serving as a server or a client when a program is transmitted through a network, such as the Internet, or a communication line, such as a telephone line. In addition, the program may be transmitted from a computer system, which has a storage unit or the like that stores the program, to another computer system through a transmission medium or through a transmission wave in the transmission medium. Here, the “transmission medium” to transmit a program refers to a medium having a function of transmitting information, such as a network (communication network) including the Internet or a communication line including a telephone line. In addition, the above-described program may be provided to realize some of the functions described above. In addition, the program may be a so-called differential file (differential program) that can realize the above-described functions in combination with a program already recorded in a computer system.

While the embodiments of the invention have been described in detail with reference to the drawings, the specific configuration is not limited to the above-described embodiments and design and the like within the scope that does not depart from the subject matter of the invention are also included.

In an embodiment of the present invention, an electronic device includes: a vibration unit that vibrates a housing on the basis of vibration information; a sound output unit that outputs a sound on the basis of sound information; a detection unit that detects the movement of the housing; a collision determination unit that determines the presence or absence of a collision of the virtual object to an inner wall of the virtual container and the presence or absence of a collision between the virtual objects by calculating the movement of a virtual container and the movement of a virtual object on the basis of the movement of the housing detected by the detection unit, the virtual container being moved according to the movement of the housing, the virtual object being moved around in the virtual container according to the movement of the virtual container; and an output information generation unit that generates the vibration information output to the vibration unit when the collision determination unit determines that there has been a collision of the virtual object to the inner wall of the virtual container and generates the sound information output to the sound output unit when the collision determination unit determines that there has been a collision between the virtual objects.

In the embodiment described above, it is possible to adopt a configuration in which the output information generation unit generates the sound information in addition to the vibration information when the collision determination unit determines that there has been a collision of the virtual object to the inner wall of the virtual container and outputs the sound information to the sound output unit at a timing delayed from the timing at which the vibration information is output to the vibration unit.

In addition, in the embodiment described above, it is possible to adopt a configuration in which the vibration unit is capable to vibrate each of a plurality of portions of the housing and the output information generation unit generates the vibration information in order to vibrate a portion corresponding to the collision point when the collision determination unit determines that there has been a collision of the virtual object to the inner wall of the virtual container.

In addition, in the embodiment described above, it is possible to adopt a configuration in which a display unit, which displays the movement of the virtual object that moves around in the virtual container, is further provided.

What is claimed is:

1. An electronic device comprising:
a detection unit configured to detect movement of a housing;
a vibration unit configured to vibrate the housing;
a determination unit configured to calculate movement of a virtual container and movement of a virtual object, and detect a relative distance between an inner wall of the virtual container and the virtual object, the virtual container being moved according to the movement of the housing, the virtual object being moved in the virtual container according to the movement of the virtual container; and
an output information generation unit configured to output vibration information used to vibrate the vibration unit to the vibration unit when the determination unit determines that the relative distance between the inner wall of the virtual container and the virtual object satisfies a predetermined distance relationship.

2. The electronic device according to claim 1,
wherein the output information generation unit outputs the vibration information to the vibration unit when the determination unit determines that the relative distance between the inner wall of the virtual container and the virtual object is equal to or less than a predetermined value.

3. The electronic device according to claim 1,
wherein the determination unit detects a relative distance between an inner wall surface of the virtual container and a surface of the virtual object facing the inner wall surface of the virtual container.

4. The electronic device according to claim 1,
wherein the output information generation unit outputs the vibration information to the vibration unit when the determination unit determines that there has been a collision of the virtual object to the inner wall of the virtual container.

5. The electronic device according to claim 1,
wherein the output information generation unit generates vibration information corresponding to a speed of collision of the virtual object to the inner wall of the virtual container, and outputs the generated vibration information to the vibration unit.

6. The electronic device according to claim 1,
wherein the output information generation unit comprises an output information storage section and an output information selection section,
the vibration information is stored in advance in the output information storage section, and
the output information selection section selects the vibration information from the output information storage section on the basis of the relative distance between the inner wall of the virtual container and the virtual object, and outputs the selected vibration information to the vibration unit, the relative distance being obtained by the determination unit.

7. The electronic device according to claim 6,
wherein the vibration information is stored in advance in the output information storage section so as to correspond to a speed of collision of the virtual object to the inner wall of the virtual container, and
the output information selection section selects the vibration information, which corresponds to the speed of collision of the virtual object to the inner wall of the virtual container, from the output information storage section and outputs the selected vibration information to the vibration unit.

8. The electronic device according to claim 1, further comprising:
a sound output unit configured to output a sound,
wherein the determination unit detects a relative distance between the virtual objects, and
the output information generation unit outputs sound information used to output the sound to the sound output unit when the determination unit determines that the relative distance between the virtual objects satisfies a predetermined distance relationship.

9. The electronic device according to claim 8,
wherein the output information generation unit outputs the vibration information to the vibration unit when the determination unit determines that the relative distance between the virtual objects is equal to or less than a predetermined value.

10. The electronic device according to claim 8,
wherein the determination unit detects a relative distance between surfaces of the virtual objects facing each other.

11. The electronic device according to claim 8,
wherein the output information generation unit outputs the sound information to the sound output unit when the determination unit determines that there has been a collision between the virtual objects.

12. The electronic device according to claim 8,
wherein the output information generation unit comprises an output information storage section and an output information selection section,
the sound information is stored in advance in the output information storage section, and
the output information selection section selects the sound information from the output information storage section on the basis of the relative distance between the virtual objects, and outputs the selected sound information to the sound output unit, the relative distance being obtained by the determination unit.

13. The electronic device according to claim 8,
wherein the output information generation unit outputs the vibration information to the vibration unit on the basis of the relative distance between the inner wall of the virtual container and the virtual object, and outputs the sound information to the sound output unit at a timing delayed from a timing at which the vibration information is output to the vibration unit, the relative distance being obtained by the determination unit.

14. The electronic device according to claim 1,
wherein the vibration unit is capable to vibrate each of a plurality of portions of the housing, and
the output information generation unit generates the vibration information in order to vibrate a portion, which corresponds to a collision point, on the basis of the relative distance between the inner wall of the virtual container and the virtual object, the relative distance being obtained by the determination unit.

15. An electronic device comprising:
a detection unit configured to detect movement of a housing;
a sound output unit configured to output a sound;
a determination unit configured to calculate movement of a virtual container and movement of a virtual object, and detects a relative distance between the virtual objects, the virtual container being moved according to the movement of the housing, the virtual object being moved in the virtual container according to the movement of the virtual container; and
an output information generation unit configured to output sound information used to output the sound to the sound output unit when the determination unit determines that the relative distance between the virtual objects satisfies a predetermined distance relationship.

16. The electronic device according to claim 15,
wherein the output information generation unit outputs the sound information to the sound output unit when the determination unit determines that the relative distance between the virtual objects is equal to or less than a predetermined value.

17. The electronic device according to claim 15,
wherein the output information generation unit outputs the sound information to the sound output unit when the determination unit determines that there has been a collision between the virtual objects.

18. The electronic device according to claim 15,
wherein the determination unit detects a relative distance between surfaces of the virtual objects facing each other.

19. The electronic device according to claim 15,
wherein the output information generation unit comprises an output information storage section and an output information selection section,
the sound information is stored in advance in the output information storage section, and
the output information selection section selects the sound information from the output information storage section on the basis of the relative distance between the virtual objects, and outputs the selected sound information to the sound output unit, the relative distance being obtained by the determination unit.

20. The electronic device according to claim 1, further comprising:
a display unit configured to display the movement of the virtual object that moves in the virtual container.
